(19) United States
(12) Patent Application Publication
(10) Pub. No.: US 2024/0190234 A1
(43) Pub. Date: Jun. 13, 2024

(54) MOUNT FOR WORK VEHICLE AND WORK VEHICLE

(71) Applicant: TADANO LTD., Kagawa (JP)

(72) Inventors: Tsubasa NISHIMARU, Kagawa (JP); Takahiro YAMASHINA, Kagawa (JP)

(73) Assignee: TADANO LTD., Kagawa (JP)

(21) Appl. No.: 18/528,332

(22) Filed: Dec. 4, 2023

(30) Foreign Application Priority Data
Dec. 13, 2022 (JP) 2022-198751

(51) Int. Cl. B60K 5/12; F16F 15/08

(52) U.S. Cl. CPC B60K 5/1208; F16F 15/08

(57) ABSTRACT

A mount for a work device includes a stopper that restrict first elastic deformation of a vibration-proof member by which a plate approaches a frame and second elastic deformation of the vibration-proof member by which the plate is apart away from the frame. The stopper includes a first stopper fixed to one of the plate and the frame, and a distal end of the first stopper protruding from the one of the plate and the frame toward the other of the plate and the frame faces the other of the plate and the frame with a gap in an up-down direction to restrict the first elastic deformation when brought into contact with the other of the plate and the frame.

### CROSS-REFERENCE TO RELATED APPLICATIONS

This application is entitled to or claims the benefit of Japanese Patent Application No. 2022-198751, filed on Dec. 13, 2022, the disclosure of which including the specification, drawings and abstract is incorporated herein by reference in its entirety.

### BACKGROUND OF THE INVENTION

### Technical Field

The present invention relates to a mount for a work vehicle and a work vehicle.

### Related Art

Conventionally, when a vibration device such as an engine is fixed to a frame of a vehicle, the vibration device is fixed to the frame using a mount for absorbing vibration of the vibration device.

For example, in JP 7113688 B2, an engine, which is a vibration device, is fixed to a pair of frames by using an engine mount, and the engine mount includes a flat plate on which the engine is placed, vibration-proof rubbers between which the flat plate is sandwiched in an up-down direction, and a bolt that fixes the vibration-proof rubbers to the frames.

As described above, in a case where the engine fixed using the engine mount is a large-scale engine mounted on a work vehicle such as a truck crane, large reaction force from the engine acts on the engine mount, and a load exceeding an allowable load may be applied to the vibration-proof rubber.

In the work vehicle, a fan fixed to the engine is covered with a shroud provided in a radiator fixed to the frame. However, displacement caused by vibration of the engine may increase, and the fan and the shroud may interfere with each other.

Therefore, the present invention provides a mount for a work vehicle capable of reducing a load applied to a vibration-proof rubber by suppressing displacement caused by vibration of a vibration device, and a work vehicle.

### SUMMARY OF THE INVENTION

In an aspect of a mount for a work vehicle according to the present invention, the mount includes:
a plate fixed to a vibration device of the work vehicle;
a vibration-proof member including a first elastic body disposed on a frame of the work vehicle and under the plate, and a second elastic body disposed on the plate, the plate being sandwiched between the first elastic body and the second elastic body in an up-down direction; and
a stopper configured to restrict first elastic deformation of the vibration-proof member by which the plate approaches the frame and second elastic deformation of the vibration-proof member by which the plate is apart away from the frame,
in which the stopper includes a first stopper fixed to one of the plate and the frame, and a distal end of the first stopper protruding from the one of the plate and the frame toward the other of the plate and the frame faces the other of the plate and the frame with a gap in the up-down direction to restrict the first elastic deformation by contacting the other of the plate and the frame.

In another aspect of the mount for a work vehicle according to the present invention, the mount further includes:
a contact plate disposed on the second elastic body; and
a fastening member configured to fasten the contact plate, the second elastic body, the plate, the first elastic body, and the frame,
in which the stopper further includes a second stopper fixed to one of the contact plate and the plate, and a distal end of the second stopper protruding from the one of the contact plate and the plate toward the other of the contact plate and the plate faces the other of the contact plate and the plate with a gap in the up-down direction to regulate the second elastic deformation by contacting the other of the contact plate and the plate.

In still another aspect of the mount for a work vehicle according to the present invention,
the first stopper is a bar-shaped member disposed along the up-down direction near the first elastic body or a cylindrical member disposed to surround an outer circumference of the first elastic body.

For example, the first stopper is a bolt as the bar-shaped member.

In still another aspect of the mount for a work vehicle according to the present invention,
the vibration-proof member includes a front vibration-proof member positioned on a front side of the plate and a rear vibration-proof member positioned on a rear side of the plate, and
the first stopper is the bar-shaped member disposed along the up-down direction at a position between a horizontal center of the front vibration-proof member and a horizontal center of the rear vibration-proof member.

In still another aspect of the mount for a work vehicle according to the present invention,
the second stopper is a cylindrical member disposed to surround an outer circumference of the second elastic body or a bar-shaped member disposed along the up-down direction near the second elastic body.

In still another aspect of the mount for a work vehicle according to the present invention, the mount further includes:
a bracket having a first connection portion connected to the plate and a second connection portion connected to the vibration device, in which
the vibration-proof member includes a front vibration-proof member positioned on a front side of the plate and a rear vibration-proof member positioned on a rear side of the plate, and
the first connection portion is connected to the plate between the front vibration-proof member and the rear vibration-proof member.

In an aspect of a work vehicle according to the present invention, the work vehicle includes:
the mount for the work vehicle;
the frame; and
the vibration device supported by the frame by using the mount.

In another aspect of the work vehicle according to the present invention,
the center of vibration of the vibration device is located at a front portion of the vibration device, and
the mount is disposed at a rear portion of the vibration device.

In still another aspect of the work vehicle according to the present invention,
the vibration-proof member is disposed at a plurality of positions on the plate.

According to the present invention, deformation of the vibration-proof rubber can be suppressed in both an expanding direction and a contracting direction of the vibration-proof rubber in the up-down direction, thereby reducing a load applied to the vibration-proof rubber. In addition, the mount can be installed in a space-saving manner.

### BRIEF DESCRIPTION OF THE DRAWINGS

FIG. 1 is a side view illustrating a truck crane;

FIG. 2 is a side view illustrating an engine supported by a frame using engine mounts;

FIG. 3 is a schematic plan view illustrating an engine supported by a frame using engine mounts;

FIG. 4 is a perspective view illustrating an engine mount disposed at a rear portion of an engine;

FIG. 5 is a plan view illustrating an engine mount disposed at a rear portion of an engine;

FIG. 6 is a side view illustrating an engine mount disposed at a rear portion of an engine;

FIG. 7 is a side cross-sectional view illustrating an engine mount disposed at a rear portion of an engine;

FIG. 8 is a side view illustrating an engine mount disposed at a front portion of an engine;

FIGS. 9A, 9B, and 9C are side cross-sectional views each illustrating a modification of a first stopper; and

FIGS. 10A, 10B, and 10C are side cross-sectional views each illustrating a modification of a second stopper.

### DESCRIPTION OF THE EMBODIMENTS

Next, modes for carrying out the present invention will be described with reference to the accompanying drawings.

### [Truck Crane]

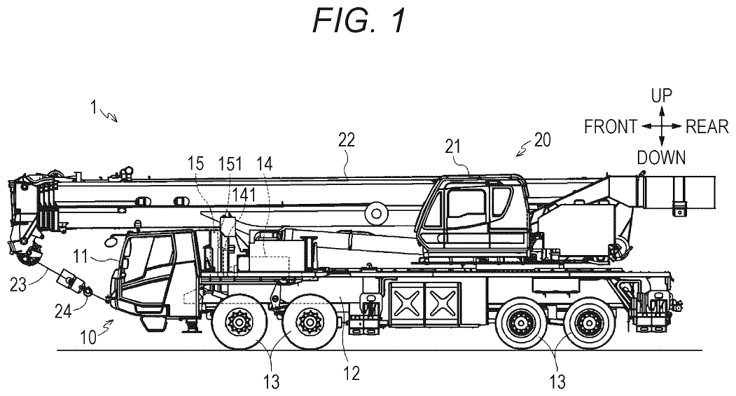

A truck crane 1 illustrated in FIG. 1 is an embodiment of a work vehicle in which a vibration device is supported by a frame using a mount for the work vehicle according to the present invention. Although the present embodiment will be described using the truck crane 1, another work vehicle, such as a loading-type truck crane including a crane device for loading and a platform for loading cargo, a high-place work vehicle with a high-place work device mounted on the vehicle, or a self-propelled crane that can be propelled by itself, can be applied as the work vehicle.

In the following description, a length direction of the truck crane 1 is defined as a front-rear direction, and a side on which a cab 11 is disposed is defined as a front side. In addition, in a posture facing the front side, a right hand side is defined as a right side of the truck crane 1, and a left hand side is defined as a left side of the truck crane 1.

In the truck crane 1, a crane device 20 is mounted on a general-purpose truck 10. However, in the truck crane 1, a dedicated truck can be used instead of the general-purpose truck 10. The truck 10 includes a cab 11, frames 12, wheels 13, an engine 14, and a radiator 15.

The cab 11 is located at a front end of the truck 10. A pair of frames 12 are provided on the left and right sides, each extending rearward from the cab 11. A plurality of wheels 13 are provided on the frame 12. The engine 14 is supported by a front portion of the frame 12. The truck 10 is configured to be able to travel by transmitting a driving force from the engine 14 to the plurality of wheels 13. The radiator 15 is located in front of the engine 14, and is fixed to the frame 12.

The crane device 20 is rotatably supported by the frame 12. The crane device 20 includes a cabin 21 and a boom 22. The boom 22 is configured to be rotatable together with the cabin 21. The boom 22 is configured to be expandable and capable of rising and falling. A wire rope 23 stretch around the boom 22, and a hook 24 is attached to the tip of the wire rope 23.

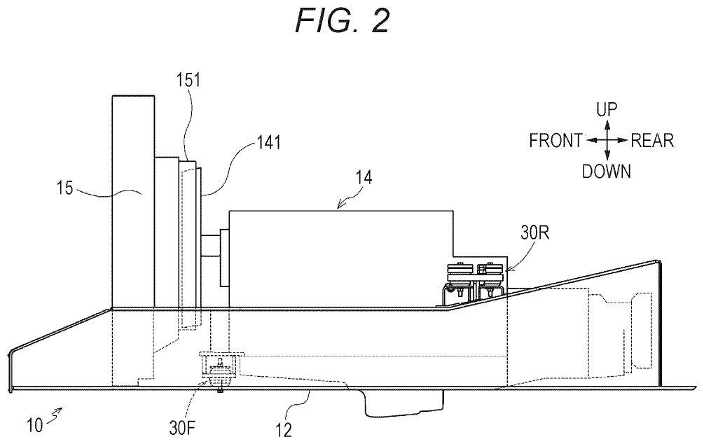

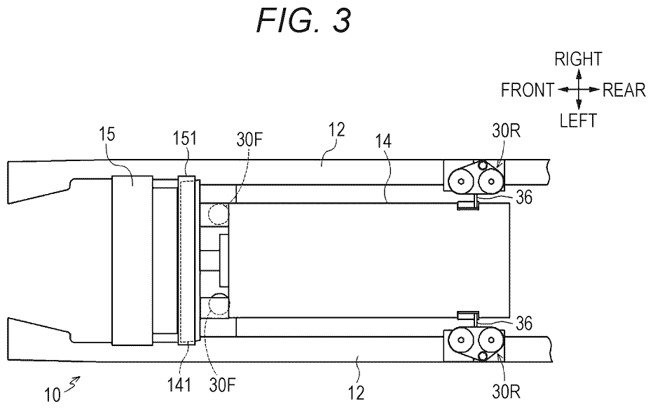

As illustrated in FIGS. 2 and 3, the engine 14 includes a fan 141 at a front end thereof, and the radiator 15 includes a shroud 151 that covers the fan 141. The engine 14 is supported by the frame 12 using engine mounts 30F and 30R. The engine mounts 30F and 30R are members for fixing the engine 14, which is a vibration device, to the frame 12 and for absorbing vibration and displacement of the engine 14 fixed to the frame 12, and are interposed between the engine 14 and the frame 12. The engine mounts 30F and 30R are examples of the mounts. A pair of engine mounts 30F are provided on the left and right sides at a front portion of the engine 14. A pair of engine mounts 30R are provided on the left and right sides at a rear portion of the engine 14.

### [Engine Mount 30R]

The engine mount 30R will be described. Note that the engine mounts 30R disposed on the left and right sides in the rear portion of the engine 14 are configured to be bilaterally symmetrical, and the other configurations are similar. Therefore, in the present embodiment, the engine mount 30R disposed on the left side will be described, and the engine mount 30R disposed on the right side will not be described.

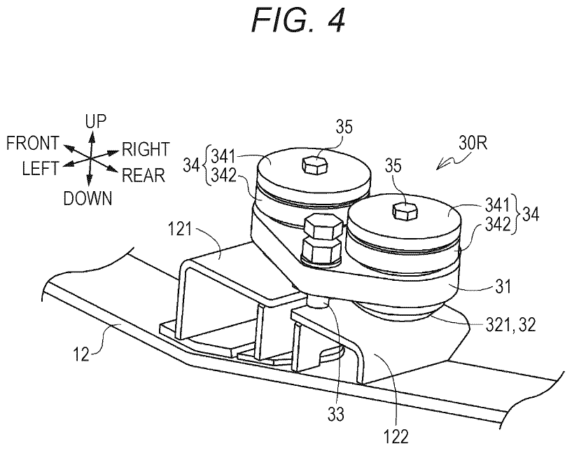

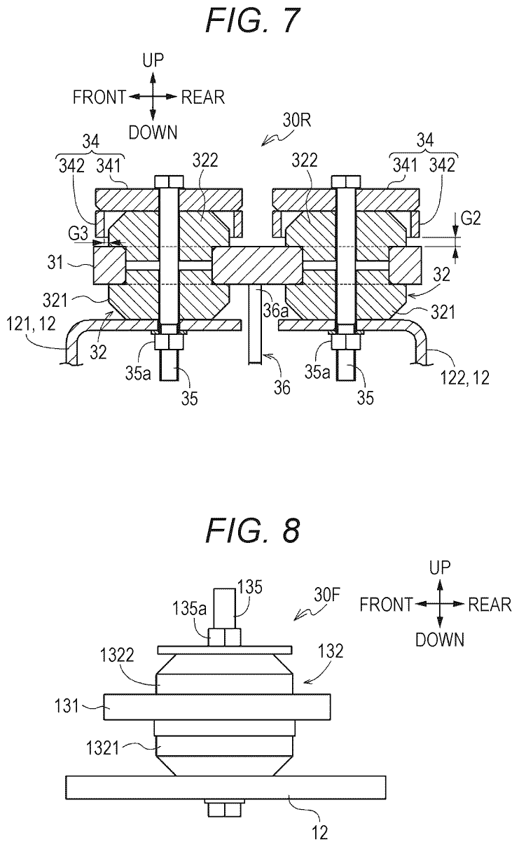

As illustrated in FIGS. 4 to 7, the engine mount 30R includes a plate 31, a vibration-proof rubber 32, a first stopper 33, a second stopper 34, a fixing bolt 35, and a bracket 36.

The plate 31 is a plate-like member facing in the up-down direction, and is fixed to the engine 14. When viewed in the up-down direction, the plate 31 is formed in a rounded triangle shape in which the bottom extends along the front-rear direction, and vertices facing each other on the bottom are located on the left and right outer sides.

The vibration-proof rubber 32 includes a first vibration-proof rubber 321 protruding downward of the plate 31 and a second vibration-proof rubber 322 protruding upward of the plate 31, and the plate 31 is vertically sandwiched between the first vibration-proof rubber 321 and the second vibration-proof rubber 322. The first vibration-proof rubber 321 is an example of a first portion of the vibration-proof rubber, and the second vibration-proof rubber 322 is an example of a second portion of the vibration-proof rubber.

The first vibration-proof rubber 321 is formed, for example, in a shape in which a truncated cone shape whose diameter decreases downward is continuous below a cylindrical shape. The second vibration-proof rubber 322 is formed, for example, in a shape in which a truncated cone shape whose diameter decreases upward is continuous above a cylindrical shape. In the engine mount 30R, the vibration-proof rubbers 32 are disposed at two locations in the front-rear direction of the plate 31. The vibration-proof rubbers 32 may be disposed at three or more locations in the front-rear direction of the plate 31.

Although the first vibration-proof rubber 321 and the second vibration-proof rubber 322 are formed separately in the present embodiment, the first vibration-proof rubber 321 and the second vibration-proof rubber 322 can be integrally formed as long as the plate 31 is sandwiched therebetween in the vertical direction.

The frame 12 includes pedestals 121 and 122 disposed in the front-rear direction, and the first vibration-proof rubbers 321 of the vibration-proof rubber 32 are fixed to the pedestals 121 and 122, respectively. The first vibration-proof rubbers 321 are fixed to the pedestals 121 and 122 so that lower surfaces of the first vibration-proof rubbers 321 and upper surfaces of the pedestals 121 and 122 are in contact with each other.

The first stopper 33 is formed of a bar-shaped member fixed to the plate 31 and protruding downward from the plate 31. In the present embodiment, a bolt is used as a bar-shaped member constituting the first stopper 33. A lower end of the bar-shaped member constituting the first stopper 33 is disposed to face the pedestal 122 of the frame 12 with a gap G1 in the up-down direction. The lower end of the bar-shaped member constituting the first stopper 33 may also be disposed to face the pedestal 121 of the frame 12 with a gap G1 in the up-down direction. The first stopper 33 is disposed at a vertex portion on an outer side in the left-right direction of the rounded triangle shape of the plate 31.

The second stopper 34 is fixed to the second vibration-proof rubber 322 of the vibration-proof rubber 32. The second stopper 34 includes a disk-shaped bottom plate 341 fixed to the second vibration-proof rubber 322, and a side wall 342 that is a cylindrical member extending downward from a peripheral edge of the bottom plate 341. The second stopper 34 is formed in a bottomed cylindrical shape by the bottom plate 341 and the side wall 342.

The bottom plate 341 is fixed to the second vibration-proof rubber 322 in a state where a lower surface of the bottom plate 341 and an upper surface of the second vibration-proof rubber 322 are in contact with each other. A lower end of the side wall 342 is disposed to face the plate 31 with a gap G2 in the up-down direction. The side wall 342 covers the entire outer circumference of the second vibration-proof rubber 322 in the circumferential direction. That is, the side wall 342 constituting the second stopper 34 is a cylindrical member that covers the outer circumference of the second vibration-proof rubber 322. The side wall 342 is disposed with a gap G3 from an outer circumferential surface of the second vibration-proof rubber 322.

The fixing bolt 35 penetrates through the bottom plate 341 of the second stopper 34, the first vibration-proof rubber 321, the plate 31, the second vibration-proof rubber 322, and each of the pedestals 121 and 122 in the up-down direction, and the second stopper 34, the first vibration-proof rubber 321, the plate 31, the second vibration-proof rubber 322, and each of the pedestals 121 and 122 are fastened to each other by the fixing bolt 35 and a nut 35a screwed to the fixing bolt 35. Thus, the second stopper 34, the vibration-proof rubbers 32, and the plate 31 sandwiched between the vibration-proof rubbers 32 are integrally connected to the frame 12.

The bracket 36 includes a first connection portion 36a connected to the plate 31 and a second connection portion 36b connected to the engine 14. The plate 31 is fixed to the engine 14 via the bracket 36. The first connection portion 36a of the bracket 36 is connected to a lower surface of the plate 31 between the vibration-proof rubber 32 located on the front side and the vibration-proof rubber 32 located on the rear side.

The engine 14 supported by the frame 12 vibrates and displaces due to traveling vibration of the truck crane 1, reaction force generated by driving the engine 14, and the like. However, in the engine mount 30R interposed between the frame 12 and the engine 14, the vibration-proof rubber 32 can be elastically deformed to absorb the vibration and displacement of the engine 14. In particular, the vibration-proof rubber 32 can expand and contract in the up-down direction to absorb the vibration and displacement in the up-down direction of the engine 14.

In this case, if the load applied to the vibration-proof rubber 32 by the vibration and displacement of the engine 14 exceeds a magnitude of load allowed by the vibration-proof rubber 32, the vibration-proof rubber 32 may be damaged. However, since the first stopper 33 and the second stopper 34 are included in the engine mount 30R, the deformation of the vibration-proof rubber 32 can be restricted to suppress an excessive load from acting on the vibration-proof rubber 32.

For example, when the vibration-proof rubber 32 is elastically deformed toward a side where the plate 31 and the frame 12 approach each other in the up-down direction, the gap G1 between the first stopper 33 and the frame 12 decreases, and the first stopper 33 comes into contact with the pedestal 122 of the frame 12. Once the first stopper 33 and the pedestal 122 are in contact with each other, further deformation of the vibration-proof rubber 32 toward a side where the plate 31 and the frame 12 approach each other can be restricted, thereby suppressing an excessive load from acting on the vibration-proof rubber 32.

When the vibration-proof rubber 32 is elastically deformed toward a side where the plate 31 and the frame 12 are apart away from each other in the up-down direction, the gap G2 between the second stopper 34 and the plate 31 decreases, and the second stopper 34 comes into contact with the plate 31. Once the second stopper 34 and the plate 31 are in contact with each other, further deformation of the vibration-proof rubber 32 toward a side where the plate 31 and the frame 12 are apart away from each other can be restricted, thereby suppressing an excessive load from acting on the vibration-proof rubber 32.

As described above, the first stopper 33 and the second stopper 34 are included in the engine mount 30R, the first stopper 33 being able to come into contact with the frame 12 when the vibration-proof rubber 32 is elastically deformed toward a side where the plate 31 and the frame 12 approach each other in the up-down direction, and the second stopper 34 being able to come into contact with the plate 31 when the vibration-proof rubber 32 is elastically deformed toward a side where the plate 31 and the frame 12 are apart away from each other in the up-down direction.

As a result, the engine mount 30R can suppress the deformation of the vibration-proof rubber 32 in both an expanding direction (a direction in which the plate 31 and the frame 12 are apart away from each other in the up-down direction) and a contracting direction (a direction in which the plate 31 and the frame 12 approach each other in the up-down direction) of the vibration-proof rubber 32 in the up-down direction, and accordingly, can reduce the load applied to the vibration-proof rubber 32.

In the truck crane 1, since the direction of the reaction force received by the frame 12 from the engine 14 is different between when the truck crane 1 moves forward and when the truck crane 1 moves backward, the first stopper 33 that restricts the deformation of the vibration-proof rubber 32 in the contracting direction and the second stopper 34 that restricts the deformation of the vibration-proof rubber 32 in the expanding direction are provided on each of the left and right engine mounts 30R.

In addition, since the second stopper 34 that restricts the deformation of the vibration-proof rubber 32 toward a side where the plate 31 and the frame 12 are apart away from each other is fixed to the second vibration-proof rubber 322 located closer to the engine 14 than the first vibration-proof rubber 321 fixed to the frame 12, the second stopper 34 can be configured small, and the engine mount 30R can be installed in a space-saving manner.

In addition, since the first stopper 33 is a bar-shaped member such as a bolt fixed to the plate 31 and protruding downward from the plate 31, the first stopper 33 can be configured with a simple configuration. Furthermore, in the second stopper 34, since the side wall 342 brought into contact with the plate 31 covers the entire outer circumference of the second vibration-proof rubber 322, the deformation of the vibration-proof rubber 32 can be restricted regardless of what position in the circumferential direction the vibration-proof rubber 32 is deformed at. In addition, since the side wall 342 of the second stopper 34 can be brought into contact with the plate 31 over a wide range, a contact pressure against the plate 31 can be small, and a magnitude of strength required by the plate 31 and the second stopper 34 can be reduced.

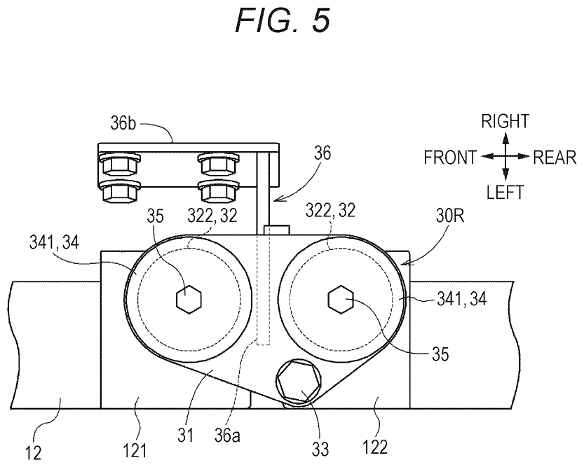

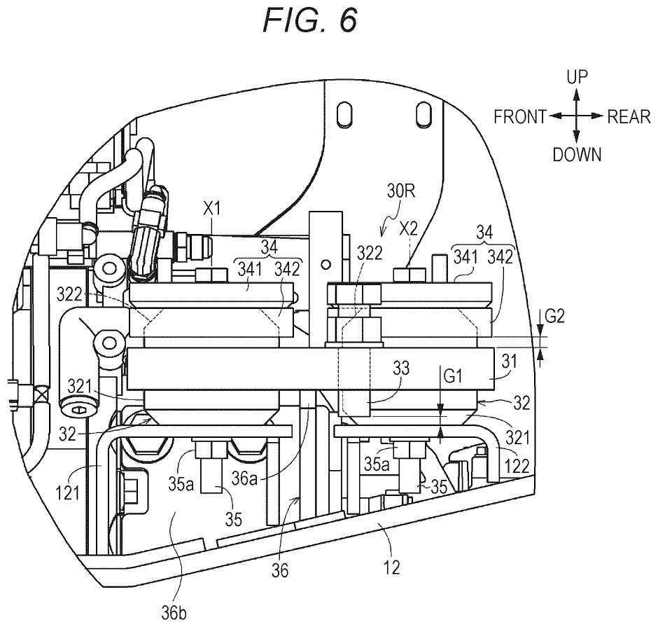

As illustrated in FIGS. 5 and 6, the first stopper 33 is disposed between the center X1 in the horizontal direction of the vibration-proof rubber 32 located on the front side in the front-rear direction and the center X2 in the horizontal direction of the vibration-proof rubber 32 located on the rear side in the front-rear direction. Therefore, the first stopper 33 can be disposed near both the front vibration-proof rubber 32 and the rear vibration-proof rubber 32, and the deformation of the front and rear vibration-proof rubbers 32 can be effectively restricted.

In addition, in the engine mount 30R, since the bracket 36 is connected to the plate 31 between the vibration-proof rubber 32 located on the front side and the vibration-proof rubber 32 located on the rear side, vibration and displacement of the engine 14 can be absorbed in a well-balanced manner by the front and rear vibration-proof rubbers 32. In addition, it is possible to suppress an increase in size of the plate 31 to which the bracket 36 is connected.

The engine 14 vibrates around a front portion thereof where the fan 141 is disposed, and thus, the displacement of the engine 14 is larger at a rear portion located away from the fan 141 than the front portion of the engine 14, and a larger load is applied to the engine mount 30R disposed at the rear portion of the engine 14. Therefore, by providing the first stopper 33 and the second stopper 34 on the engine mount 30R disposed at the rear portion of the engine 14, deformation of the vibration-proof rubber 32 on the engine mount 30R can be effectively suppressed, thereby reducing a load applied to the engine mount 30R.

In addition, by providing the vibration-proof rubbers 32 at a plurality of positions of the plate 31 on the engine mount 30R disposed at the rear portion of the engine 14, an overall allowable load of the engine mount 30R can be increased. As a result, vibration and displacement can be sufficiently absorbed at the rear portion of the engine 14 where the displacement is large.

Although the vibration-proof rubbers 32 are provided at a plurality of positions in the front-rear direction on the engine mount 30R according to the present embodiment, the vibration-proof rubber 32 can be provided only at one position as long as vibration and displacement can be sufficiently absorbed. In this case, the vibration-proof rubber 32 is disposed at a portion of the engine 14 as rear as possible to effectively absorb vibration.

### [Engine Mount 30F]

The engine mount 30F will be described. Note that the engine mounts 30F disposed on the left and right sides in the front portion of the engine 14 are similarly configured.

As illustrated in FIG. 8, the engine mount 30F includes a plate 131, a vibration-proof rubber 132, and a fixing bolt 135. The plate 131 is a plate-like member facing in the up-down direction, and is fixed to the engine 14.

The vibration-proof rubber 132 includes a first vibration-proof rubber 1321 protruding downward of the plate 131 and a second vibration-proof rubber 1322 protruding upward of the plate 131, and the plate 131 is vertically sandwiched between the first vibration-proof rubber 1321 and the second vibration-proof rubber 1322.

The first vibration-proof rubber 1321 is formed, for example, in a shape in which a truncated cone shape whose diameter decreases downward is continuous below a cylindrical shape. The second vibration-proof rubber 1322 is formed, for example, in a shape in which a truncated cone shape whose diameter decreases upward is continuous above a cylindrical shape.

The first vibration-proof rubber 1321 of the vibration-proof rubber 132 is fixed to the frame 12. The first vibration-proof rubber 1321 is fixed to the frame 12 so that a lower surface of the first vibration-proof rubber 1321 is in contact with the frame 12.

The fixing bolt 135 penetrates through the first vibration-proof rubber 1321, the plate 131, the second vibration-proof rubber 1322, and the frame 12 in the up-down direction, and the first vibration-proof rubber 1321, the plate 131, the second vibration-proof rubber 1322, and the frame 12 are fastened to each other by the fixing bolt 135 and a nut 135a screwed to the fixing bolt 135. Thus, the vibration-proof rubbers 132 and the plate 31 sandwiched between the vibration-proof rubbers 32 are integrally connected to the frame 12.

In the engine mount 30F interposed between the frame 12 and the engine 14, the vibration-proof rubber 132 can be elastically deformed to absorb vibration and displacement of the engine 14. In particular, the vibration-proof rubber 132 can expand and contract in the up-down direction to absorb the vibration and displacement in the up-down direction of the engine 14.

Since the magnitude of vibration and displacement at the front portion of the engine 14 is smaller than that at the rear portion of the engine 14, the load applied to the vibration-proof rubber 132 is unlikely to exceed the allowable load of the vibration-proof rubber 132. Therefore, the engine mount 30F does not include stoppers such as the first stopper 33 and the second stopper 34 provided in the engine mount 30R.

Since the engine mount 30F can be configured compactly by not including stoppers such as the first stopper 33 and the second stopper 34, it is possible to reduce restrictions on where to dispose the engine mount 30F.

However, the engine mount 30F can also be configured to include stoppers such as the first stopper 33 and the second stopper 34. In addition, in the engine mount 30F, a plurality of vibration-proof rubbers 132 may be disposed on the plate 131.

Although the present embodiment has been described using an example in which the mount for the work vehicle is applied to the engine mounts 30F and 30R for supporting the engine 14, the mount for the work vehicle can also be applied to a mount for supporting another vibration device. Examples of the vibration device supported by the mount for the work vehicle include a transmission that changes the driving force from the engine 14, a transfer that transmits the driving force from the engine 14 to the front and rear wheels in a distributed manner, and a retarder that is an auxiliary brake for decelerating the vehicle. The vibration device supported by the mount for the work vehicle may be a device that vibrates by generating a driving force by itself, or may be a device that vibrates by a driving force from another device.

### [Modification of First Stopper]

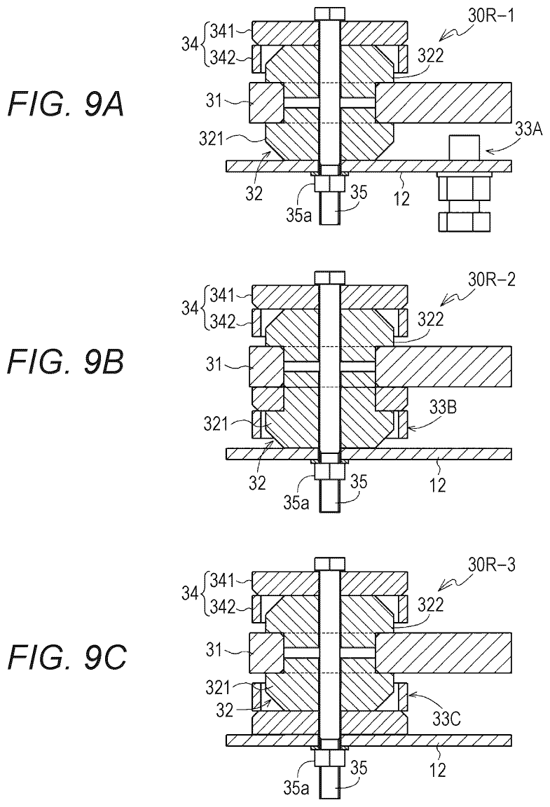

The first stopper 33 included in the engine mount 30R is formed of a bolt fixed to the plate 31 and protruding downward from the plate 31. However, as illustrated in FIG. 9A, the first stopper 33 can be configured like a first stopper 33A included in an engine mount 30R-1. The engine mount 30R-1 is configured similarly to the engine mount 30R except that the first stopper 33A is provided instead of the first stopper 33. Note that, in FIGS. 9A, 9B, and 9C, only one vibration-proof rubber 32 is illustrated.

The first stopper 33A is formed of a bolt fixed to the frame 12 and protruding upward from the frame 12. The first stopper 33A is disposed to face the plate 31 with a gap in the up-down direction. When the vibration-proof rubber 32 is elastically deformed toward a side where the plate 31 and the frame 12 approach each other in the up-down direction, the first stopper 33A comes into contact with the plate 31, and further deformation of the vibration-proof rubber 32 toward the side where the plate 31 and the frame 12 approach each other is restricted.

As illustrated in FIG. 9B, the first stopper 33 included in the engine mount 30R can be configured like a first stopper 33B included in an engine mount 30R-2. The engine mount 30R-2 is configured similarly to the engine mount 30R except that the first stopper 33B is provided instead of the first stopper 33.

The first stopper 33B includes a cylindrical member fixed to the plate 31 and protruding downward from the plate 31, and covers the entire outer circumference of the first vibration-proof rubber 321 in the circumferential direction. That is, the first stopper 33B is formed of a cylindrical member that covers the outer circumference of the first vibration-proof rubber 321 in the vibration-proof rubber 32. The first stopper 33B is disposed to face the frame 12 with a gap in the up-down direction. When the vibration-proof rubber 32 is elastically deformed toward a side where the plate 31 and the frame 12 approach each other in the up-down direction, the first stopper 33B comes into contact with the frame 12, and further deformation of the vibration-proof rubber 32 toward the side where the plate 31 and the frame 12 approach each other is restricted.

As illustrated in FIG. 9C, the first stopper 33 included in the engine mount 30R can be configured like a first stopper 33C included in an engine mount 30R-3. The engine mount 30R-3 is configured similarly to the engine mount 30R except that the first stopper 33C is provided instead of the first stopper 33.

The first stopper 33C includes a cylindrical member fixed to the frame 12 and protruding upward from the frame 12, and covers the entire outer circumference of the first vibration-proof rubber 321 in the circumferential direction. That is, the first stopper 33C is formed of a cylindrical member that covers the outer circumference of the first vibration-proof rubber 321 in the vibration-proof rubber 32. The first stopper 33C is disposed to face the plate 31 with a gap in the up-down direction. When the vibration-proof rubber 32 is elastically deformed toward a side where the plate 31 and the frame 12 approach each other in the up-down direction, the first stopper 33C comes into contact with the plate 31, and further deformation of the vibration-proof rubber 32 toward the side where the plate 31 and the frame 12 approach each other is restricted.

### [Modification of Second Stopper]

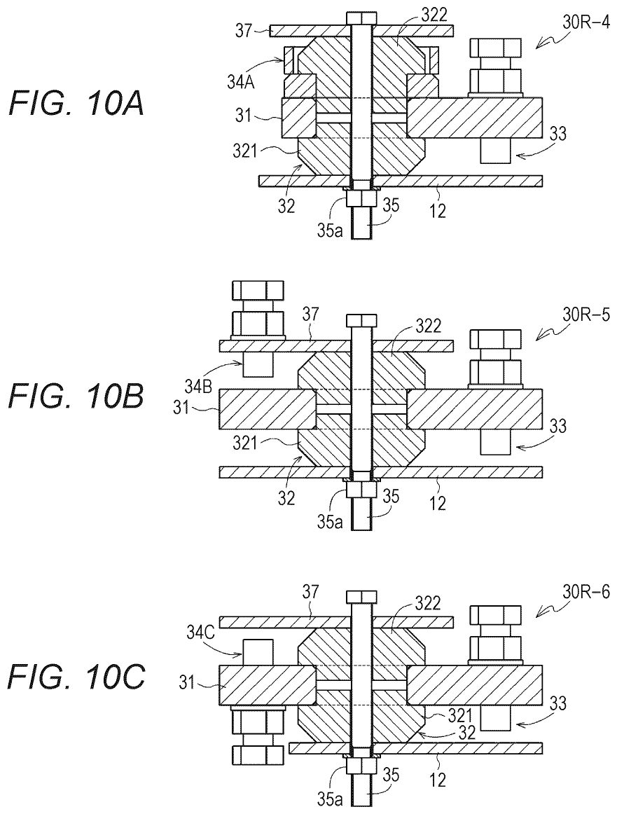

The second stopper 34 included in the engine mount 30R includes the side wall 342 that is a cylindrical member fixed to the second vibration-proof rubber 322 of the vibration-proof rubber 32, and extending downward from an upper end side of the second vibration-proof rubber 322. However, as illustrated in FIG. 10A, the second stopper 34 can be configured like a second stopper 34A included in an engine mount 30R-4. The engine mount 30R-4 is different from the engine mount 30R in that the second stopper 34A is provided instead of the second stopper 34, and a plate-like contact plate 37 fixed to an upper surface of the second vibration-proof rubber 322 is provided in the vibration-proof rubber 32. The contact plate 37 is an example of a contact member. The other configurations of the engine mount 30R-4 are similar to those of the engine mount 30R. In FIGS. 10A, 10B, and 10C, only one vibration-proof rubber 32 is illustrated.

The second stopper 34A includes a cylindrical member fixed to the plate 31 and protruding upward from the plate 31, and covers the entire outer circumference of the second vibration-proof rubber 322 in the circumferential direction. That is, the second stopper 34A is formed of a cylindrical member that covers the outer circumference of the second vibration-proof rubber 322 in the vibration-proof rubber 32. The second stopper 34A is disposed to face the contact plate 37 with a gap in the up-down direction. When the vibration-proof rubber 32 is elastically deformed toward a side where the plate 31 and the frame 12 are apart away from each other in the up-down direction, the second stopper 34A comes into contact with the contact plate 37, and further deformation of the vibration-proof rubber 32 toward the side where the plate 31 and the frame 12 are apart away from each other is restricted.

As illustrated in FIG. 10B, the second stopper 34 of the engine mount 30R can be configured like a second stopper 34B included in an engine mount 30R-5. The engine mount 30R-5 is different from the engine mount 30R in that the second stopper 34B is provided instead of the second stopper 34, and a plate-like contact plate 37 fixed to an upper surface of the second vibration-proof rubber 322 is provided in the vibration-proof rubber 32. The other configurations of the engine mount 30R-5 are similar to those of the engine mount 30R.

The second stopper 34B is formed of a bolt fixed to the contact plate 37 and protruding downward from the contact plate 37. The second stopper 34B is disposed to face the plate 31 with a gap in the up-down direction. When the vibration-proof rubber 32 is elastically deformed toward a side where the plate 31 and the frame 12 are apart away from each other in the up-down direction, the second stopper 34B comes into contact with the plate 31, and further deformation of the vibration-proof rubber 32 toward the side where the plate 31 and the frame 12 are apart away from each other is restricted.

As illustrated in FIG. 10C, the second stopper 34 included in the engine mount 30R can be configured like a second stopper 34C included in an engine mount 30R-6. The engine mount 30R-6 is different from the engine mount 30R in that the second stopper 34C is provided instead of the second stopper 34, and a plate-like contact plate 37 fixed to an upper surface of the second vibration-proof rubber 322 is provided in the vibration-proof rubber 32. The other configurations of the engine mount 30R-6 are similar to those of the engine mount 30R.

The second stopper 34C is formed of a bolt fixed to the plate 31 and protruding upward from the plate 31. The second stopper 34C is disposed to face the contact plate 37 with a gap in the up-down direction. When the vibration-proof rubber 32 is elastically deformed toward a side where the plate 31 and the frame 12 are apart away from each other in the up-down direction, the second stopper 34C comes into contact with the contact plate 37, and further deformation of the vibration-proof rubber 32 toward the side where the plate 31 and the frame 12 are apart away from each other is restricted.

### [Combination of First Stopper and Second Stopper]

In the engine mount 30R, the first stoppers 33, 33A, 33B, and 33C and the second stoppers 34, 34A, 34B, and 34C can be arbitrarily combined and used.

That is, in addition to the use of the first stopper 33 and the second stopper 34 in combination as illustrated in FIG. 6, the use of the second stopper 34 and each of the first stoppers 33A, 33B, and 33C in combination as illustrated in FIGS. 9A, 9B, and 9C, and the use of the first stopper 33 and each of the second stoppers 34A, 34B, and 34C in combination as illustrated in FIGS. 10A, 10B, and 10C, it is also possible to use the first stopper 33A and each of the second stoppers 34A, 34B, and 34C in combination, use the first stopper 33B and each of the second stoppers 34A, 34B, and 34C in combination, and use the first stopper 33C and each of the second stoppers 34A, 34B, and 34C in combination.

What is claimed is:

1. A mount for a work vehicle, the mount comprising:
a plate fixed to a vibration device of the work vehicle;
a vibration-proof member including a first elastic body disposed on a frame of the work vehicle and under the plate, and a second elastic body disposed on the plate, the plate being sandwiched between the first elastic body and the second elastic body in an up-down direction; and
a stopper configured to restrict first elastic deformation of the vibration-proof member by which the plate approaches the frame and second elastic deformation of the vibration-proof member by which the plate is apart away from the frame,
wherein the stopper includes a first stopper fixed to one of the plate and the frame, and a distal end of the first stopper protruding from the one of the plate and the frame toward the other of the plate and the frame faces the other of the plate and the frame with a gap in the up-down direction to restrict the first elastic deformation by contacting the other of the plate and the frame.

2. The mount for a work vehicle according to claim 1, further comprising:
a contact plate disposed on the second elastic body; and
a fastening member configured to fasten the contact plate, the second elastic body, the plate, the first elastic body, and the frame,
wherein the stopper further includes a second stopper fixed to one of the contact plate and the plate, and a distal end of the second stopper protruding from the one of the contact plate and the plate toward the other of the contact plate and the plate faces the other of the contact plate and the plate with a gap in the up-down direction to regulate the second elastic deformation by contacting the other of the contact plate and the plate.

3. The mount for a work vehicle according to claim 1, wherein the first stopper is a bar-shaped member disposed along the up-down direction near the first elastic body or a cylindrical member disposed to surround an outer circumference of the first elastic body.

4. The mount for a work vehicle according to claim 3, wherein the first stopper is a bolt as the bar-shaped member.

5. The mount for a work vehicle according to claim 3, wherein the vibration-proof member includes a front vibration-proof member positioned on a front side of the plate and a rear vibration-proof member positioned on a rear side of the plate, and
the first stopper is the bar-shaped member disposed along the up-down direction at a position between a horizontal center of the front vibration-proof member and a horizontal center of the rear vibration-proof member.

6. The mount for a work vehicle according to claim 2, wherein the second stopper is a cylindrical member disposed to surround an outer circumference of the second elastic body or a bar-shaped member disposed along the up-down direction near the second elastic body.

7. The mount for a work vehicle according to claim 1, further comprising:
a bracket having a first connection portion connected to the plate and a second connection portion connected to the vibration device, wherein
the vibration-proof member includes a front vibration-proof member positioned on a front side of the plate and a rear vibration-proof member positioned on a rear side of the plate, and
the first connection portion is connected to the plate between the front vibration-proof member and the rear vibration-proof member.

8. A work vehicle comprising:
the mount for a work vehicle according to claim 1;
the frame; and
the vibration device supported by the frame by using the mount.

9. The work vehicle according to claim 8, wherein
the center of vibration of the vibration device is located at a front portion of the vibration device, and
the mount is disposed at a rear portion of the vibration device.

10. The work vehicle according to claim 9, wherein the vibration-proof member is disposed at a plurality of positions on the plate.
